(19) United States
(12) Patent Application Publication
(10) Pub. No.: US 2026/0233708 A1
(43) Pub. Date: Aug. 13, 2026

(54) MOTOR VEHICLE AND WINDSCREEN WIPER UNIT

(71) Applicant: FLEXIS, BOULOGNE-BILLANCOURT (FR)

(72) Inventors: Emmanuel BARREIRO, VILLIERS SAINT-FREDERIC (FR); Ludovic BOURDON, GUYANCOURT (FR); Alberto RAMOS, VILLIERS-SAINT-FREDERIC (FR)

(21) Appl. No.: 19/539,679

(22) Filed: Feb. 13, 2026

(30) Foreign Application Priority Data
Feb. 13, 2025 (FR) FR2501512

(51) Int. Cl. B60S 1/52; B60S 1/08; B60S 1/38; B60S 1/40

(52) U.S. Cl. CPC B60S 1/524; B60S 1/08; B60S 1/38; B60S 1/3881; B60S 1/40

(57) ABSTRACT

The wiper unit includes: a wiper blade designed to wipe a window of the motor vehicle; an arm on which the wiper blade is mounted; a drive configured to move the arm relative to the window in a pivoting motion, the drive having a drive shaft of the arm to which one end of the arm is fixed; a gutter placed under the window and configured to collect water running off the window; the gutter having an opening through which the drive shaft passes, the opening being surrounded by a rib with a closed contour, preventing water from entering the opening.

### INCORPORATION BY REFERENCE TO ANY PRIORITY APPLICATIONS

Any and all applications for which a foreign or domestic priority claim is identified in the Application Data Sheet as filed with the present application are hereby incorporated by reference.

### FIELD

The present disclosure generally relates to a windscreen wiper unit for a motor vehicle.

### SUMMARY

It is possible to include in such a unit:
a wiper blade designed to wipe a window of the motor vehicle;
an arm on which the wiper blade is mounted;
a drive configured to move the arm relative to the window in a pivoting motion, the drive having a drive shaft of the arm to which one end of the arm is fixed;
a gutter placed under the window and configured to collect water running off the window.

The gutter may include an opening through which the drive shaft passes.

In this case, water running off the windshield passes through the gap between the drive shaft and the edge of the opening. A water box is provided in the engine compartment, under the opening, to collect the water passing through the opening.

Adding a water box makes the wiper unit more complex and costly. The assembly of the wiper unit takes longer.

In this context, the present disclosure aims to propose a wiper unit that does not have the above defect.

To this end, the present disclosure relates to a wiper unit for a motor vehicle, the unit comprising:
a wiper blade designed to wipe a window of the motor vehicle;
an arm on which the wiper blade is mounted;
a drive configured to move the arm relative to the window in a pivoting motion, the drive having a drive shaft of the arm (9) to which one end of the arm is fixed;
a gutter placed under the window and configured to collect water running off the window; the gutter having an opening through which the drive shaft passes, the opening being surrounded by a closed-contour rib, preventing water from entering the opening.

The closed-contour rib surrounding the opening prevents water from entering the opening. Therefore, there is no longer any water flow between the drive shaft and the edge of the opening. Consequently, it is no longer necessary to provide a water box to collect water entering through the opening.

The wiper unit is of simpler design, and its assembly is faster.

The wiper unit may also include one or more of the following features, considered individually or in any technically possible combination:
the gutter comprises a transverse channel and an inclined panel interposed between the channel and the window so that water running off the window passes through the inclined panel before being collected in the channel, the opening being formed in the inclined panel;
the transverse channel and the inclined panel are made of plastic material;
the rib is formed by a raised edge of the opening;
the rib is circular, the end of the arm including a cylindrical outer edge surrounding the rib;
the end of the arm including a cylindrical inner edge, the cylindrical inner edge and the cylindrical outer edge defining between them a groove wherein the rib is placed;
the wiper unit comprises:
another wiper blade designed to wipe the window of the motor vehicle;
another arm on which the other wiper blade is mounted; the drive having another drive shaft of the other arm to which one end of the other arm is fixed,
the gutter having another opening through which the other drive shaft passes, the other opening being surrounded by another closed-contour rib, preventing water from entering the other opening;
the opening and the other opening are placed at two opposite transverse ends of the gutter.

According to a second aspect, the present disclosure relates to a motor vehicle comprising a window and a wiper unit having the above features, designed to wipe said window.

Advantageously, the window is the windshield of the motor vehicle.

### BRIEF DESCRIPTION OF THE DRAWINGS

Other features and advantages of the present disclosure will become apparent from the detailed description given below, by way of indication and not limitation, with reference to the appended figures, among which:

FIG. 1 is a perspective view of a part of a motor vehicle, showing in particular the windshield and the wiper unit according to the present disclosure;

FIG. 2 is a simplified schematic representation of the windshield and the wiper unit shown in FIG. 1, considered in section in a plane perpendicular to the transverse direction;

FIG. 3 is a schematic representation of the end of the arm of the wiper unit shown in FIG. 2, considered according to the incidence of arrow III shown in FIG. 2; and

FIG. 4 is a perspective view of the end of the arm mounted on the drive shaft, a profile of the gutter and the end of the arm being superimposed on this figure.

### DETAILED DESCRIPTION

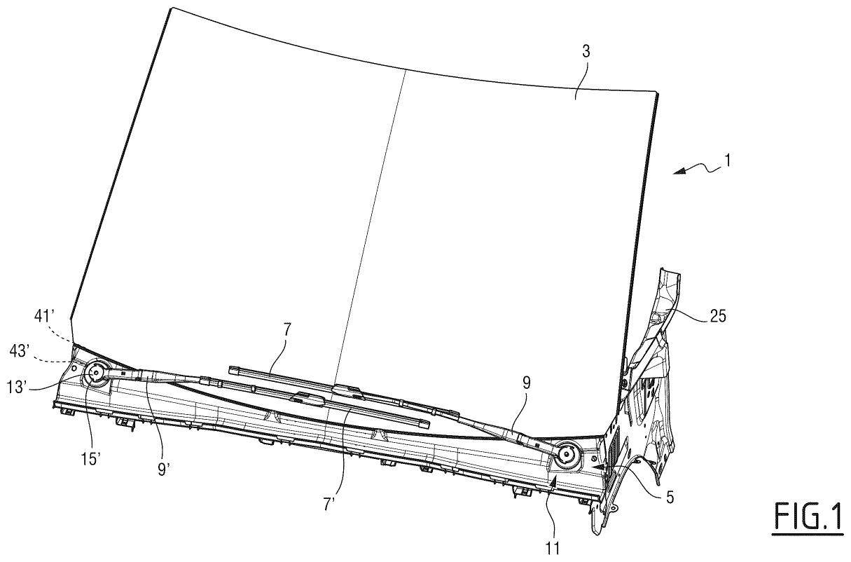

The motor vehicle 1 partially shown in FIG. 1 includes a window 3 and a wiper unit 5, designed to wipe said window 3.

The window is typically the windshield of the motor vehicle.

Alternatively, it is the rear window of the vehicle or any other window of this vehicle.

According to another variant, this window is part of a light projector of the vehicle.

The wiper unit 5 comprises:
a wiper blade 5, designed to wipe the window 3 of the motor vehicle;
an arm 7, on which the wiper blade 5 is mounted;
a drive 9, configured to move the arm 7 relative to the window 3 in a pivoting motion.

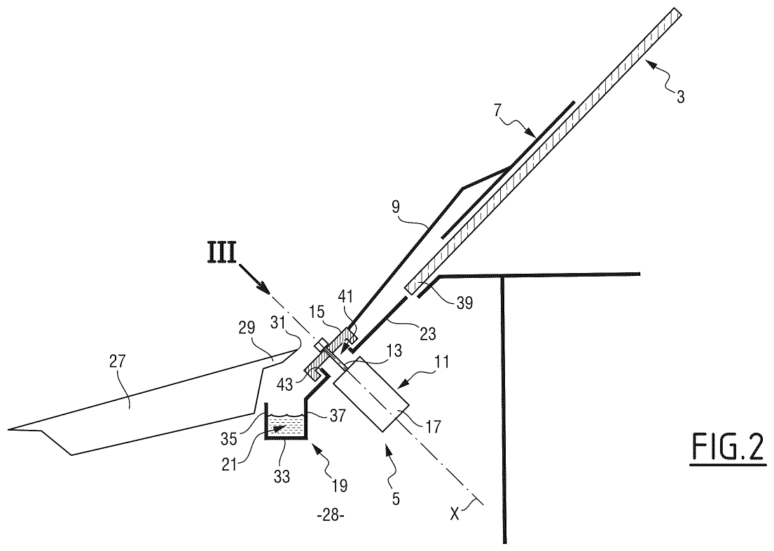

The drive 11, as seen in FIG. 2, includes a drive shaft 13 of the arm 9, to which one end 15 of said arm is fixed. The drive shaft 13 extends along an axis X.

For example, the drive 11 includes a motor 17, whose output shaft rotates the drive shaft 13.

The output shaft, for example, is directly connected to the drive shaft 13. Alternatively, the drive 11 includes a kinematic chain connecting the output shaft to the drive shaft 13.

The arm 7 is typically driven in a rotational motion around a rotation axis coinciding with axis X. Alternatively, the arm 7 is driven in a more complex motion, during which the drive shaft 13 moves relative to the window 3.

As seen in FIGS. 1 and 2, the unit 5 also includes a gutter 19, placed under the window 3 and configured to collect water running off the window 3.

The gutter comprises a transverse channel 21 and an inclined panel 23 interposed between the channel 21 and the window 3, so that water running off the window 3 passes through the panel 23 before being collected in the channel 21.

The transverse channel 21 and the inclined panel 23 are made of plastic material.

For example, the gutter is an injection-molded plastic part.

The channel 21 is open at the top.

The channel 21 extends transversely across the entire width of the windshield 3. It is open at its two transverse ends, so that the water collected in the channel 21 flows between the bodywork and the wheel arch liner 25, visible in FIG. 1.

In the example shown, the channel 21 has, in section perpendicular to the transverse direction, a U-shaped section open at the top.

As seen in FIG. 2, the motor vehicle includes a front hood 27.

The front hood 27 closes the engine compartment 28.

The hood 27 is delimited towards the rear of the vehicle by a rear transverse edge 29. A gap 31 separates the inclined panel 23 from the rear transverse edge 29.

The channel 21 is placed under the rear transverse edge 29 of the hood.

The channel 21 includes a bottom 33, a front wall 35, and a rear wall 37.

As seen in FIG. 2, the inclined panel 23 extends upwards and rearwards from the gutter 21 to a lower edge 39 of the window 3.

More precisely, the inclined panel 23 extends from the rear wall 37 of the channel to the lower edge 39 of the window 3.

In the example shown where the window 3 is the windshield of the vehicle, the window 3 extends from the lower edge 39 upwards and rearwards of the vehicle.

As seen in FIG. 2, the gutter 19 includes an opening 41 through which the drive shaft 13 passes.

The opening 41 is formed in the inclined panel 23.

The opening 41 has a much larger section than the cross-section of the drive shaft 13, to account for the position tolerance of this shaft 13 in the opening 41.

Advantageously, the opening 41 is surrounded by a closed-contour rib 43 preventing water from entering the opening 41. In other words, water running off the window 3 and then flowing over the inclined panel 23 cannot enter the opening 41. The rib 43 diverts the water around the opening 41, this water flowing into the channel 21 and not into the opening 41.

Advantageously, the rib 43 is formed by a raised edge of the opening 41. In other words, the edge 43 of the opening 41 forms a cylinder surrounding the opening 41.

The opening 41 is formed in a flat area 45 of the inclined wall. The raised edge 43 protrudes relative to the flat area 45. The central axis of the raised edge 43 is substantially perpendicular to the flat area 45.

This central axis typically coincides with axis X.

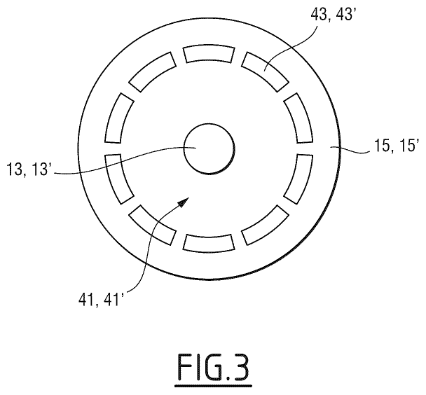

In FIG. 3, the rib 43 is shown in dashed lines because it is seen through the end 15 of the arm. This rib 43 is practically continuous and does not have interruptions through which water could flow.

As seen in FIG. 3, the rib 43 is typically circular.

The end of the arm 15 has a general disk shape.

It includes a bottom 47 with a relatively thicker central part 49 rigidly fixed to the drive shaft 13, and a relatively thinner annular peripheral part 51, extending around the central part 49 and integral with it.

The outer surface of the bottom 47, opposite the opening 41, is stepped along axis X. At the central part 49, the outer surface is offset at a greater distance from the opening 41 than at the annular part 51.

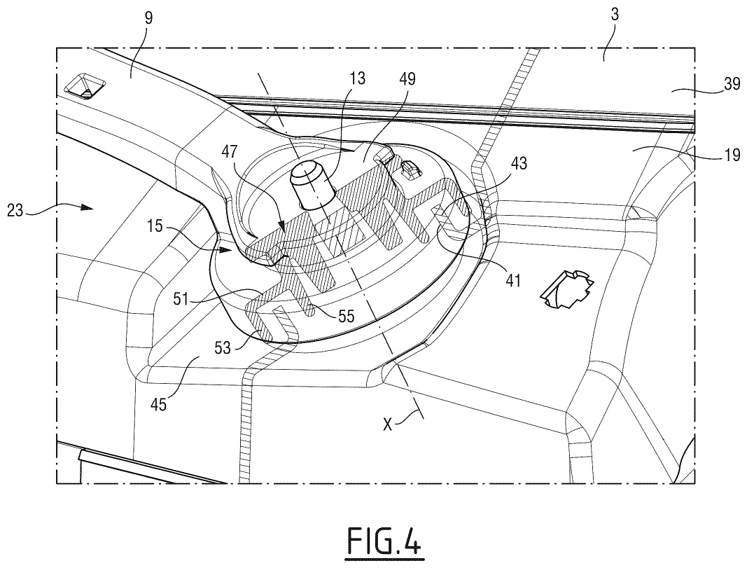

As seen in the section superimposed on FIG. 4, the end 15 of the arm 9 includes a cylindrical outer edge 53 surrounding the rib 43. The cylindrical outer edge 53 is carried by the radially outer edge of the bottom 47. It protrudes from the annular peripheral part 51 towards the opening 41 along axis X.

The end 15 of the arm also includes a cylindrical inner edge 55, the cylindrical inner edge 55 and the cylindrical outer edge 53 defining between them a groove 57 wherein the rib 43 is placed.

The cylindrical inner edge 55 protrudes axially from the bottom 47 towards the opening 41. It is placed inside the rib 43. It extends substantially at the junction between the central part 49 and the annular peripheral part 51.

The groove 57 is thus delimited by the annular peripheral part 51, by the cylindrical inner edge 55, and by the cylindrical outer edge 53.

The rib 43 is engaged without direct or indirect contact with the cylindrical inner edge 55 or the cylindrical outer edge 53.

There is no seal between the end 15 of the arm and the rib 43 or the drive shaft 13.

The groove 57 and the rib 43 thus constitute a kind of labyrinth seal preventing water from entering the opening 41, even when the flow of water running off the window 3 is very high.

Typically, and as illustrated in FIG. 1, the unit 5 comprises another wiper blade 7′ designed to wipe the window 3 of the motor vehicle, and another arm 9′ on which the other wiper blade 7′ is mounted.

The drive 11 in this case is configured to move the other arm 9′ relative to the window 3 in a pivoting motion.

The drive 11 then includes another drive shaft 13′, visible in FIG. 1, driving the other arm 9′. One end 15′ of the other arm is fixed on the other drive shaft 13′.

The other drive shaft 13′ is driven in rotation by the motor 7, via a kinematic chain not shown here.

Alternatively, the other drive shaft 13′ is driven in rotation by another motor, synchronized with motor 17.

In the example shown in FIG. 1, the drive shaft 13 and the other drive shaft 13′ are located at two opposite transverse edges of the windshield 3.

The arm 9 and the other arm 9′ pivot in opposite directions. When the arm 9 pivots clockwise, the arm 9′ pivots counterclockwise. Conversely, when the arm 9 pivots counterclockwise, the arm 9′ pivots clockwise.

The gutter 21 then includes another opening 41′ through which the other drive shaft 13′ passes. The other opening 41′ is surrounded by another closed-contour rib 43′, preventing water from entering the other opening 41′.

The other rib 43′ is like the rib 43.

The end 15′ of the other arm 9′ is like the end 15 of the arm 9.

The present disclosure is particularly advantageous in the configuration with two openings 41, 41′ placed at the two opposite transverse ends of the gutter 21. Due to the large size of this gutter 21, the position tolerance of the openings 41, 41′ relative to the drive shafts 13, 13′ is significant. It is therefore necessary to create large openings to pass the drive shafts 13, 13′.

The water flow inside the openings, in the absence of ribs 43, 43′, would be particularly significant.

Alternatively, the wiper unit comprises only one wiper blade and one arm.

It has been described above that the closed-contour rib preventing water from entering the opening was the raised edge of the opening. Alternatively, this rib is formed in the gutter, i.e., is made of material with the gutter, but is not the edge of the opening. According to another variant, the closed-contour rib is attached to the gutter.

In the example described above, the transverse channel and the inclined panel are made of material with each other. Alternatively, they are two separate parts, fixed to each other.

What is claimed is:

1. A wiper unit for a motor vehicle, the wiper unit comprising:
a wiper blade configured to wipe a window of the motor vehicle;
an arm on which the wiper blade is mounted;
a drive configured to move the arm relative to the window in a pivoting motion, the drive having a drive shaft of the arm to which one end of the arm is fixed; and
a gutter configured to be placed under the window and configured to collect water running off the window,
the gutter having an opening through which the drive shaft passes, the opening being surrounded by a rib with a closed contour, preventing water from entering the opening.

2. The wiper unit according to claim 1, wherein the gutter comprises a transverse channel and an inclined panel interposed between the transverse channel and the window so that water running off the window passes through the inclined panel before being collected in the transverse channel, the opening being formed in the inclined panel.

3. The wiper unit according to claim 2, wherein the transverse channel and the inclined panel are made of plastic material.

4. The wiper unit according to claim 1, wherein the rib is formed by a raised edge of the opening.

5. The wiper unit according to claim 1, wherein the rib is circular, and the end of the arm comprises a cylindrical outer edge surrounding the rib.

6. The wiper unit according to claim 5, wherein the end of the arm comprises a cylindrical inner edge, wherein the cylindrical inner edge and the cylindrical outer edge define between them a groove wherein the rib is placed, the rib being engaged without direct or indirect contact with the cylindrical inner edge or the cylindrical outer edge.

7. The wiper unit according to claim 1, further comprising:
another wiper blade configured to wipe the window of the motor vehicle; and
another arm on which said another wiper blade is mounted,
the drive having another drive shaft of said another arm to which one end of said another arm is fixed,
the gutter having another opening through which said another drive shaft passes, said another opening being surrounded by another rib with a closed contour, preventing water from entering said another opening.

8. The wiper unit according to claim 7, wherein the opening and said another opening are placed at two opposite transverse ends of the gutter.

9. A motor vehicle comprising a window and a wiper unit according to claim 1, the wiper unit configured to wipe said window.

10. The motor vehicle according to claim 9, wherein the window is a windshield of the motor vehicle.
